(19) United States
(12) Patent Application Publication
(10) Pub. No.: US 2026/0087342 A1
(43) Pub. Date: Mar. 26, 2026

(54) SYSTEM AND METHOD FOR ACCELERATING DIFFUSION SAMPLING WITH PROGRESSIVE CONSISTENCY TRAINING

(71) Applicant: NVIDIA Corporation, Santa Clara, CA (US)

(72) Inventors: Sangyun Lee, Pittsburgh, PA (US); Weili Nie, Sunnyvale, CA (US); Yilun Xu, Santa Clara, CA (US); Arash Vahdat, San Mateo (CA); Karsten Julian Kreis, Vancouver (CA); Tomas Geffner, Santa Clara, CA (US)

(21) Appl. No.: 19/039,513

(22) Filed: Jan. 28, 2025

Related U.S. Application Data
(60) Provisional application No. 63/699,714, filed on Sep. 26, 2024.

(51) Int. Cl. G06N 3/08; G06T 11/00

(52) U.S. Cl. CPC G06N 3/08; G06T 11/00

(57) ABSTRACT

Systems and methods are disclosed that perform a truncated consistency model training framework that includes two stages. For example, in the first stage, embodiments of the present disclosure may train a consistency model using first and second time step samples. The first time step samples may be obtained based on sampling from a plurality of time steps. Following, a truncated time range that does not include all of the time steps from the plurality of time steps is obtained. Then, third time step samples are obtained based on sampling from the truncated time range and fourth time step samples are determined based on the third time step samples and a time step difference. Afterwards, in a second stage, the consistency model is further trained using the third time step samples and the fourth time step samples.

### CLAIM OF PRIORITY

This application claims the benefit of U.S. Provisional Application No. 63/699,714 (Attorney Docket No. 515020) titled “System and Method for Accelerating Diffusion Sampling with Progressive Consistency Training,” filed Sep. 26, 2024, the entire contents of which is incorporated herein by reference.

### BACKGROUND

Diffusion models have demonstrated great performance in generating images, videos, and/or other modalities. However, the generation process of diffusion models is very slow and tedious as the process requires numerous forward-passes through the diffusion model to generate the output. Given a massive demand in speed, especially from real-time applications, more recently proposed models, including consistency models, have shown promising results in reducing the sampling process. For example, consistency models have recently been introduced to accelerate sampling from diffusion models by directly predicting the solution (e.g., data) of the probability flow (PF) ordinary differential equation (ODE). However, the training of consistency models requires learning to map all the intermediate points along the PF ODE trajectories to their corresponding endpoints. This task is even more challenging than the ultimate objective of one-step generation, which is concerned primarily with the PF ODE's noise-to-data mapping. As such, this training paradigm limits the one-step generation performance of traditional consistency models. Therefore, there is a need for addressing these issues and/or other issues associated with the prior art.

### SUMMARY

Embodiments of the present disclosure relate to systems and methods for accelerating diffusion sampling with progressive consistency training. For instance, systems and methods are disclosed that describe a multi-stage training framework for training consistency models (e.g., truncated consistency models) that explicitly allocates network capacity towards generation while preserving consistency mapping.

For example, consistency models have recently been introduced to accelerate sampling from diffusion models by directly predicting the solution (e.g., data) of the PF ODE from initial noise. However, the training of consistency models requires learning to map all intermediate points along PF ODE trajectories to their corresponding endpoints. This task is much more challenging than the ultimate objective of one-step generation, which only concerns the PF ODE's noise-to-data mapping. Furthermore, it was empirically found that this training paradigm limits the one-step generation performance of consistency models. To address this issue and in contrast to conventional systems, such as those described above, embodiments of the present disclosure generalize consistency training to the truncated time range, which allows the model to ignore denoising tasks at earlier time steps and focus its capacity on generation. Additionally, and/or alternatively, embodiments of the present disclosure describe a new parameterization of the consistency function and a two-stage training procedure that prevents the truncated-time training from collapsing to a trivial solution.

In some instances, embodiments of the present disclosure describe a new training algorithm and/or model (e.g., a truncated consistency model training framework for training truncated consistency models (TCM)), which de-emphasizes denoising at smaller times while still preserving the consistency mapping for larger times. For example, embodiments of the present disclosure may utilize a multi-stage training framework that includes a first stage and a second stage. The first stage includes training a consistency model using standard consistency training and the second stage includes training a truncated consistency model using truncated consistency training. The truncated consistency training includes obtaining time step samples that are within a truncated time range [t′, T]. Furthermore, at the second stage, the training of the truncated consistency model utilizes a boundary loss and a consistency loss. The boundary loss is determined based on a first stage consistency model and a second stage consistency model (e.g., a copy of the first stage consistency model that is further trained during the second stage) and the consistency loss is determined based on using the second stage consistency model.

In an embodiment, a computer-implemented method for performing a truncated consistency model training framework is provided. The method comprises obtaining one or more first time step samples based on sampling from a plurality of time steps and determining one or more second time step samples based on the one or more first time step samples. The method further comprises training a consistency model at a first stage using the one or more first time step samples and the one or more second time step samples. Further, subsequent to training the consistency model at the first stage, the method includes obtaining a truncated time range associated with a subset of the plurality of time steps and the truncated time range does not include all of the time steps from the plurality of time steps. The method further includes obtaining one or more third time step samples based on sampling from the truncated time range, determining one or more fourth time step samples based on the one or more third time step samples and a time step difference, and training the consistency model at a second stage using the one or more third time step samples and the one or more fourth time step samples.

### BRIEF DESCRIPTION OF THE DRAWINGS

The present systems and methods for accelerating diffusion sampling with progressive consistency training are described in detail below with reference to the attached drawing figures, wherein:

FIG. 1A shows a noising and denoising task across a plurality of time steps, in accordance with an embodiment;

FIG. 1B shows a multi-stage training framework for training truncated consistency models, in accordance with an embodiment;

FIG. 1C shows an overview of training a truncated consistency model, in accordance with an embodiment;

FIG. 1D shows an exemplary process for performing a second stage of the multi-stage training framework for training truncated consistency models, in accordance with an embodiment;

FIG. 1E shows an algorithm for performing truncated consistency training, in accordance with an embodiment;

FIGS. 2A-2D show graphical representations of a denoising Fréchet inception distance (dFID) at different time steps and a plurality of training iterations, in accordance with an embodiment.

FIG. 3 provides a flow diagram illustrating a method for performing a truncated consistency model training framework, in accordance with an embodiment;

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to accelerated diffusion sampling with progressive consistency training, and in particular, to performing a truncated consistency model training framework that addresses the limitations of conventional consistency models. For instance, diffusion models have demonstrated remarkable capabilities in generating high-quality continuous data such as images, videos, and/or audio. Their generation process gradually transforms a simple Gaussian prior into data distribution through a PF ODE. Although diffusion models may capture complex data distributions, they require longer generation time due to the iterative nature of solving the PF ODE.

Consistency models were recently proposed to expedite the generation speed of diffusion models by learning to directly predict the solution of the PF ODE from the initial noise in a single step. To circumvent the need for simulating a large number of noise-data pairs to learn this mapping, as employed in conventional approaches, consistency models learn to minimize the discrepancy between the model's outputs at two neighboring points along the ODE trajectory. The boundary condition at t=0 serves as an anchor, grounding these outputs to the real data. Through simulation-free training, the consistency model gradually refines its mapping at different times, propagating the boundary condition from t=0 to the initial t=T.

However, the advantage of simulation-free training comes with trade-offs. For instance, conventional consistency models may learn to map any point along the PF ODE trajectory to its corresponding data endpoint. But, this requires the learning of both denoising at smaller times on the PF ODE, where the data is only partially corrupted, and generation towards t=T, where most of the original data information has been erased. This dual task necessitates larger network capacity, and it is challenging for a single model to excel at both tasks. Further, it was shown through empirical observations that conventional consistency model would gradually sacrifice its denoising capability at smaller times to trade for generation quality as training proceeds. While this behavior is desirable as the end goal is generation rather than denoising, an explicit control over this trade-off may be desired rather than allowing the consistency model to allocate capacity uncontrollably across times. As such, embodiments of the present disclosure may reduce the network capacity dedicated to the denoising task in-order-to improve generation.

For instance, embodiments of the present disclosure may relax the original consistency objective, which requires learning across the entire time range [0, T] of PF ODE trajectories, to a new objective that focuses on a truncated time range [t′, T], where t′ serves as the dividing time between denoising and generation tasks. This may allow the consistency model (e.g., the truncated consistency model) to dedicate its capacity primarily to generation, freeing it from the denoising task at earlier times [0, t′). In addition, it was shown that a proper boundary condition at t′ is useful to ensure that the new model adheres to the original consistent mapping. To achieve this, embodiments of the present disclosure utilize a two-stage training procedure. The first stage involves pretraining a standard consistency model over the whole time range. This pretrained model then acts as the boundary condition at t′ for the subsequent truncated consistency training stage of the truncated consistency model.

Experimentally, it was shown that the truncated consistency model training framework improves both the sample quality and the training stability of consistency models across different datasets and sampling steps. For example, it was shown that the truncated consistency model outperforms the previous best conventional consistency model in both one-step and two-step generation using a similar network size. Furthermore, the truncated consistency model even outperforms another conventional consistency model that utilizes a two times larger network across datasets and sampling steps. By using the largest network, embodiments of the present disclosure achieved a one-step Fréchet inception distance (FID) of 2.20, which is competitive with the current state-of-the-art. In addition, the divergence observed during standard consistency training is not present in the truncated consistency model training framework.

In some examples, based on an identification of an underlying trade-off between denoising and generation within consistency models, which negatively impacts both stability and generation performance, embodiments of the present disclosure build on these insights to perform a truncated consistency model training framework, which is a two-stage training framework that explicitly allocates network capacity towards generation while preserving consistency mapping. Furthermore, it was shown through extensive validation that the truncated consistency model that was used trained using this framework demonstrates significant improvements in both one-step and two-step generation, including achieving state-of-the-art results within the consistency models family on multiple image datasets. In addition, it was also shown that the truncated consistency model training framework exhibits improved training stability.

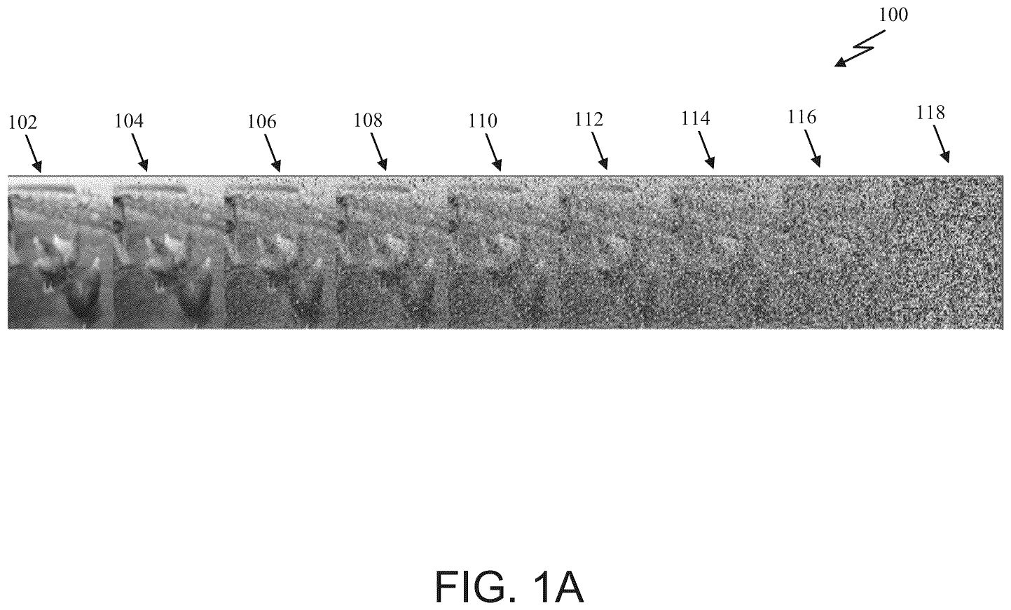

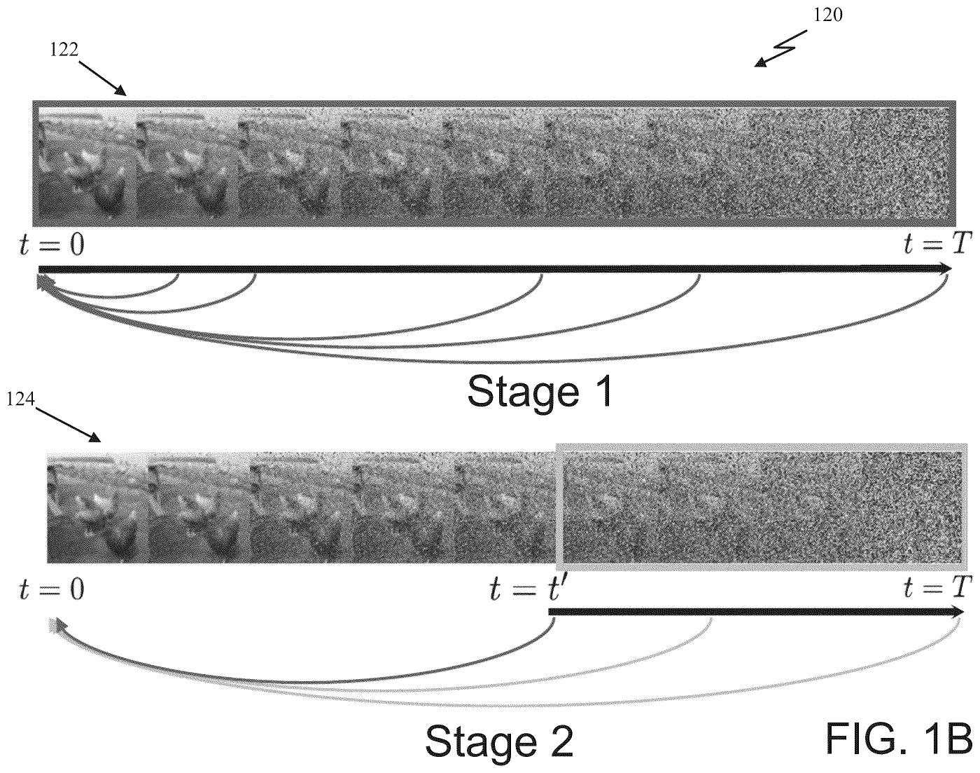

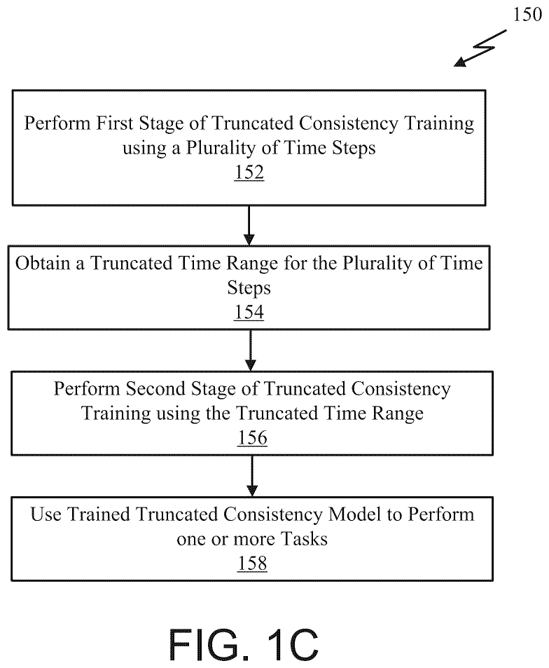

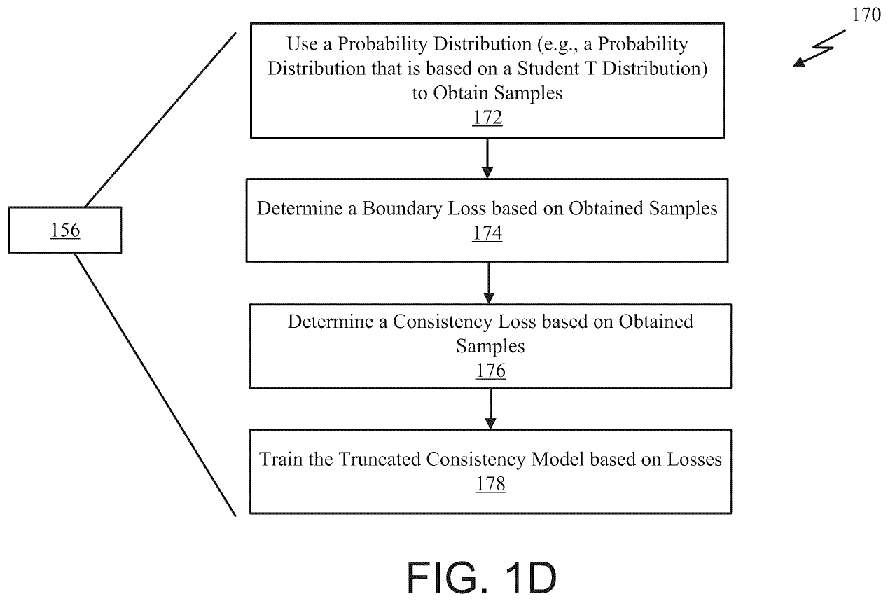

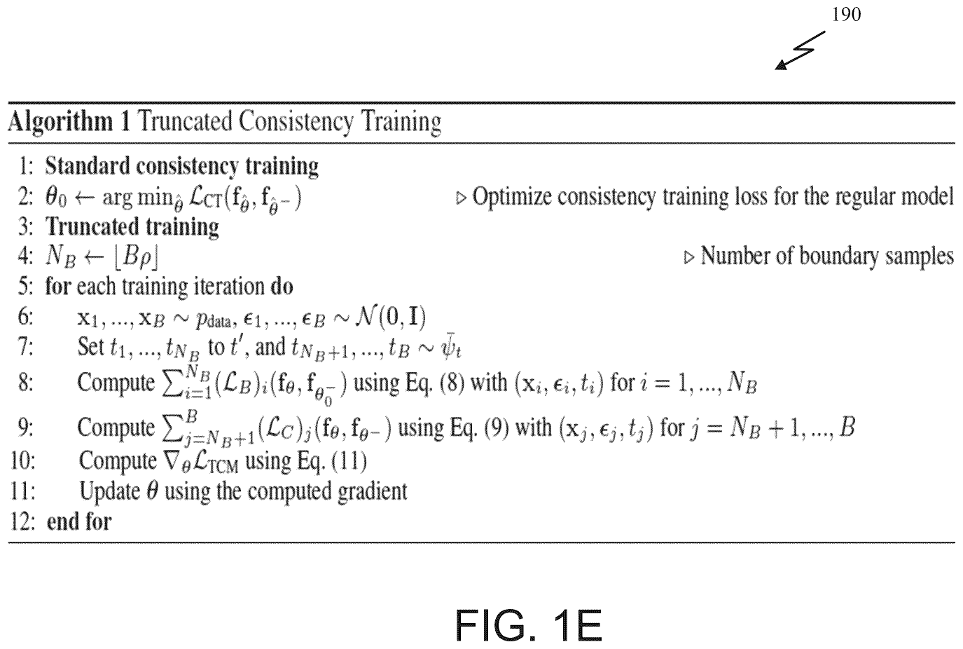

FIG. 1A shows a noising and denoising task 100 across a plurality of time steps 102-118, in accordance with an embodiment. For example, in diffusion model training, at each time step, noise is added to the original data (e.g., the image at time step 102) until reaching the last time step 118. Thus, the first time step (e.g., the time step 102 where the time (t) is equal to 0) would indicate the clean data (e.g., the original image) and the last time step (e.g., the time step 118 where t is equal to T) is complete noise (e.g., noise that may be indicated as a Gaussian distribution). Then, after adding noise to the image, the reverse process is performed using a diffusion model. For instance, at each time step in reverse (e.g., from time step 118 back to time step 102), the diffusion model removes an amount of noise from the current data (e.g., by predicting an amount of noise that is within the current image associated with the time step). As such, both during training and inference, each time step may require a forward-pass of the diffusion model, which substantially slows down the generation process.

In other words, diffusion models are a class of generative models that synthesize data by reversing a forward process in which the data distribution p_{data} is gradually transformed into a tractable Gaussian distribution. In some embodiments, a formulation where the forward process is defined by the following stochastic differential equation (SDE) is used:

$${dx}_{t} = \sqrt{2 t} {dw}_{t} , \qquad ( 1 )$$

where t∈[0, T] and wₜ is the standard Brownian motion from t=0 to t=T. Here, pₜ is defined as the marginal distribution of xₜ along the forward process, where p₀=p_{data}. In this case, pₜ is a perturbed data distribution with the noise from [symbol] (0, t²I). In diffusion models, T is set to be large enough so that p_{T} is approximately equal to a tractable Gaussian distribution [symbol] (0, T²I).

Diffusion models come with the reverse PF ODE that starts from t=T to t=0 and yields the same marginal distribution pₜ as the forward process in Equation (Eq.) (1):

$${dx}_{t} = - {ts}_{t} ( {x}_{t} ) dt , \qquad ( 2 )$$

where sₜ(xₜ): =∇ₓ log pₜ(x) is the score function at time t∈[0, T]. To draw samples from the data distribution p_{data}, a neural network is first trained to learn sₜ(x) using the denoising score matching, x_{T} is initialized with a sample from [symbol] (0, T²I), and the PF ODE is solved backward in time:

$${x}_{0} = {x}_{T} + {\int }_{T}^{0} ( - {ts}_{t} ( {x}_{t} ) ) dt$$

However, numerically solving the PF ODE requires multiple forward passes of the neural score function estimator, which is computationally expensive. Thus, consistency models have been introduced to speed up the generation process by using a one function call (e.g., one forward-pass). For instance, consistency models instead aim to directly map from noise to data, by learning a consistency function that outputs the solution of the PF ODE starting from any t∈[0, T]. The desired consistency function f may satisfy the following two properties: (i) f(x₀, 0)=x₀, and (ii) f(xₜ, t)=f(xₛ, s), ∀(s, t)∈[0, T]². The first condition may be satisfied by the reparameterization

$${f}_{θ} ( x , t ) := {c}_{out} ( t ) {F}_{θ} ( x , t ) + {c}_{skip} ( t ) x , \qquad ( 3 )$$

where θ is the parameter of the free-form neural network F_{θ}: [symbol] cₒᵤₜ(0)=0, and cₛₖᵢₚ(0)=1. Here, instead of training f_{θ} directly, a surrogate neural network F_{θ} is trained under the above reparameterization. The second condition may be learned by optimizing the following consistency training objective:

$${ℒ}_{CT} ( {f}_{θ} , {f}_{θ}^{-} ) := {𝔼}_{t ∼ {ψ}_{t} , x ∼ {p}_{data} , ϵ ∼ 𝒩 ( 0 , I )} [ \frac{ω ( t )}{{Δ}_{t}} d ( {f}_{θ} ( x + t ϵ , t ) , {f}_{{θ}^{-}} ( x + ( t - {Δ}_{t} ) ϵ , t - {Δ}_{t} ) ] , \qquad ( 4 )$$

where θ⁻=stopgrad(θ), ψₜ denotes the probability of sampling time t that also represents the noise scale, ∈ denotes the standard Gaussian noise, ω(t) is a weighting function, d(⋅,⋅) is a distance function, and Δₜ represents the nonnegative difference between two consecutive time steps that is usually set to a monotonically increasing function of t.

In addition, the gradient of [symbol] with respect to θ is an approximation of the underlying consistency distillation loss with a O(maxₜΔₜ) error. It was previously empirically suggested that Δₜ should be large at the beginning of training, which incurs biased gradients but allows for stable training, and should be annealed in the later stages, which reduces the error term but increases variance.

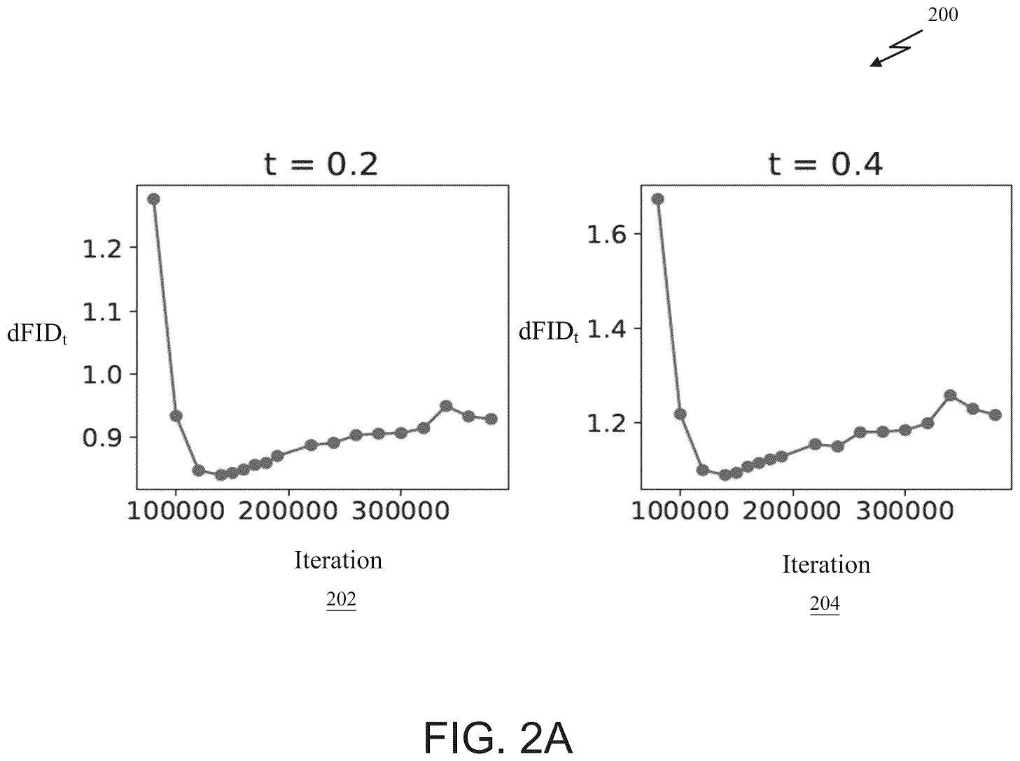

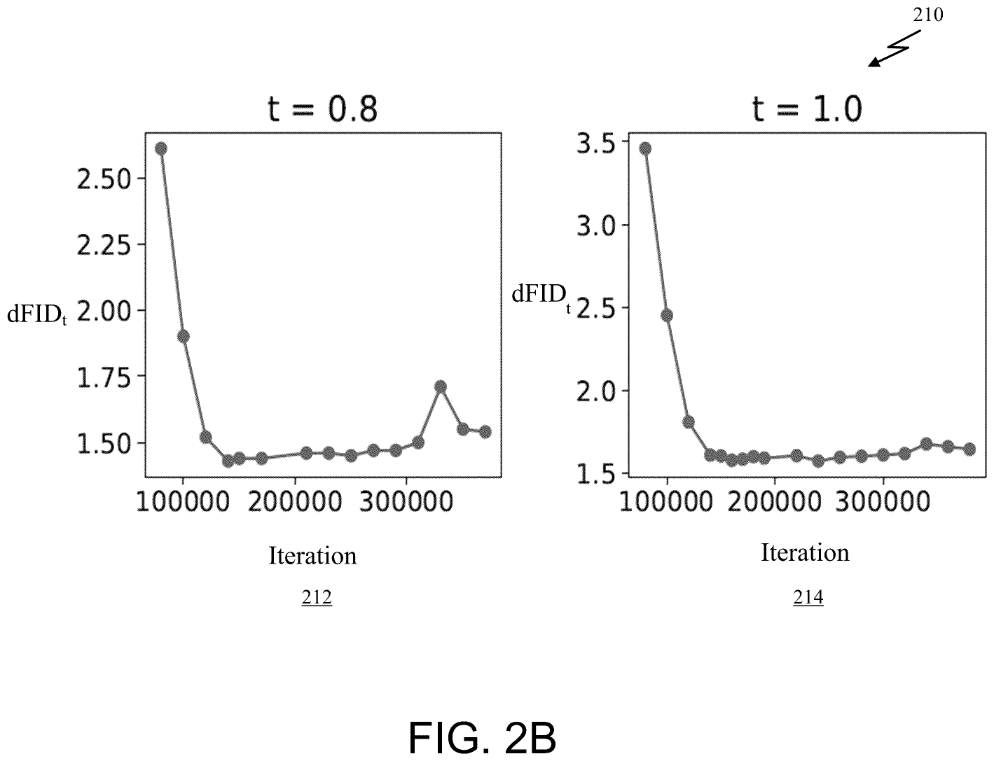

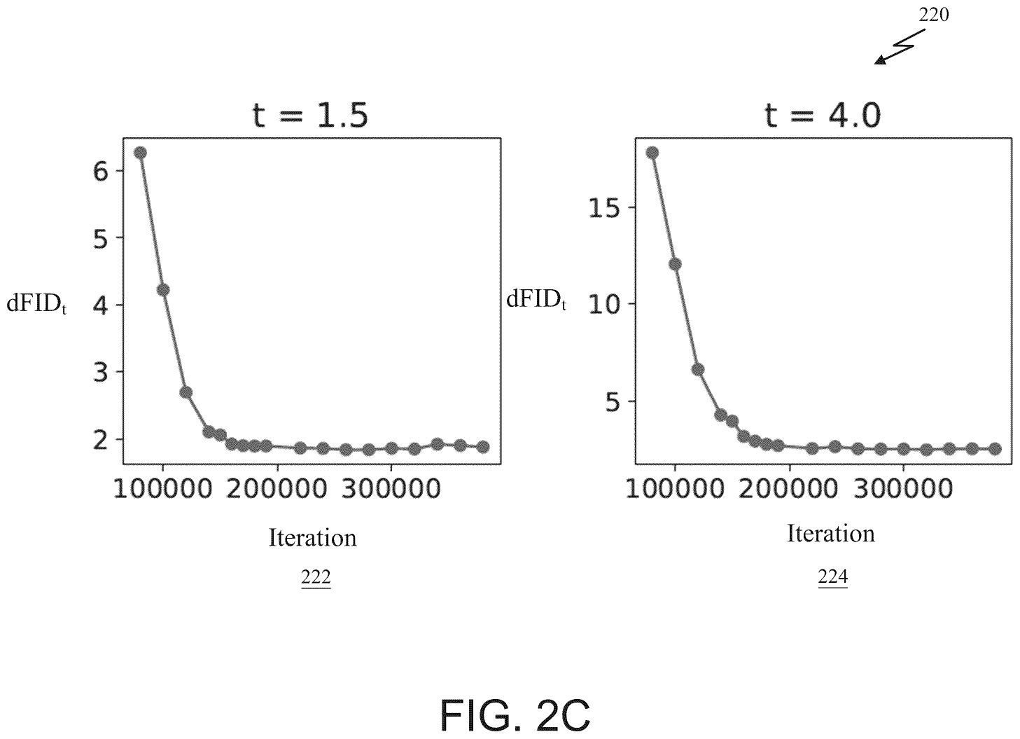

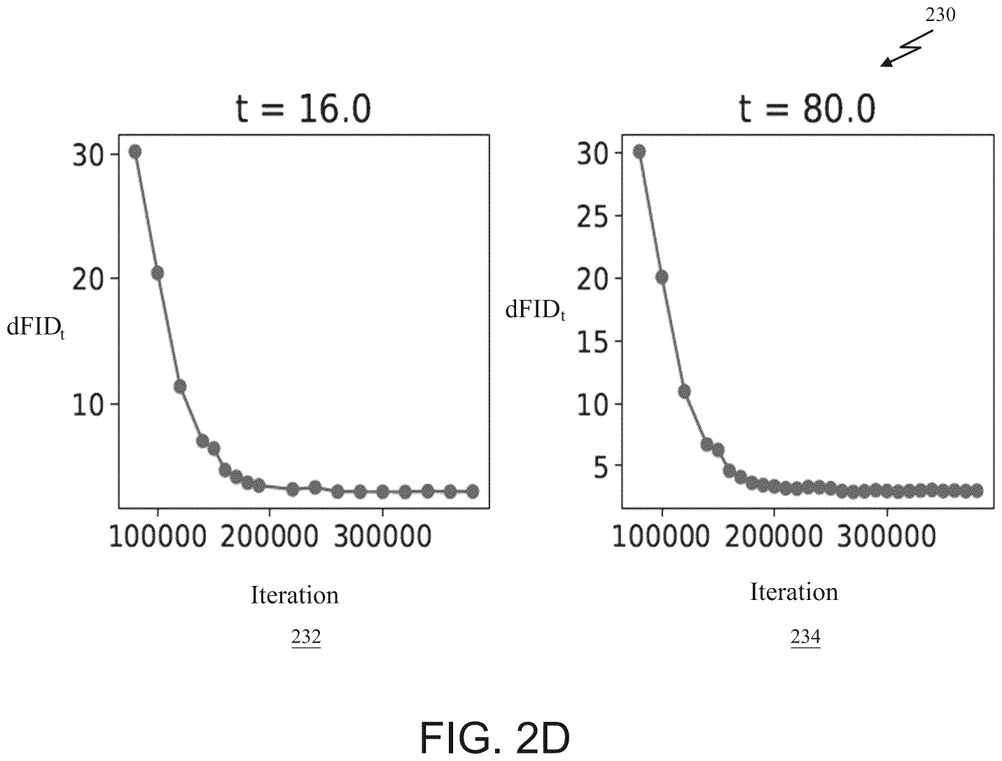

Denoising FID is described next. For instance, by definition, consistency models may both generate data from pure Gaussian noise as well as noisy data sampled from pₜ where 0<t<T. Empirically measuring the denoising capability of consistency models across different time steps may be needed to understand how consistency models propagate end solutions through diffusion time. To this end, a denoising FID (dFID) at time step t may be defined as the Fréchet inception distance (FID) between the original data p_{data} and the denoised data by consistency models with inputs sampled from pₜ. When computing dFIDₜ, Gaussian noise from [symbol] (0, t²I) is first added to 50,000 clean samples and then they are denoised using consistency models. Hence, dFID₀ is close to zero, and dFID_{T} is the standard FID. This is shown in FIGS. 2A-2D and will be described in further detail below.

In other words, referring to the functionality of consistency models, instead of removing noise at each time step, which requires numerous forward-passes of the model, the consistency model attempts to generate the clean data (e.g., the image at time step 102) from any other time step from t=0 (e.g., at time step 102) to t=T (e.g., at time step 118). To put it another way, based on integrating the data at a first sampled time step (e.g., time step 112), the consistency model may generate the clean data (e.g., the clean image at time step 102) directly.

However, it was shown that to promote data generation, consistency models sacrifice denoising performance at the earlier time steps to further improve the one step generation of the data at later time steps. For instance, at inference, the consistency model is used to generate clean data (e.g., an image or a video) from noise (e.g., a Gaussian distribution of noise such as the noise at the time step 118 (t=T)). Thus, generating clean data from noise may be referred to as data generation or a generation task. But, during the training process, the consistency model is also used for denoising tasks (e.g., denoising the data associated with any time step other than the final step 118 (t=T)) to generate the clean image as the consistency model is configured to map any of the intermediate points along the PF ODE trajectories (e.g., at any time step from t=0 to t=T other than t=T) to their corresponding endpoints (e.g., back to t=0). Therefore, the consistency model is required to divide its capacity between denoising tasks and generation tasks, which mainly contributes to the model's underperformance relative to other generative models with similar network capacities. In view of the above, given that the consistency model gradually loses its denoising capabilities at a lower t (e.g., when t is less than 1.0), this indicates that the consistency model struggles to learn to denoise and generate simultaneously, and thus sacrifices one for the other.

In other words, standard consistency models pose a higher challenge in training than many other generative models because instead of simply mapping noise to data, consistency models must learn the mapping from any point along the PF ODE trajectory to its data endpoint. Hence, a consistency model must divide its capacity between denoising tasks (e.g., mapping samples from intermediate times to data) and generation (e.g., mapping from pure noise to data). This challenge mainly contributes to consistency models' underperformance relative to other generative models with similar network capacities. It was found that standard consistency models navigate the trade-off between denoising and generation tasks implicitly. For instance, it was observed that during standard consistency training, the model gradually loses its denoising capabilities at low t. Specifically, FIGS. 2A-2D show a trade-off in which, after some training iterations, denoising FIDs at lower t (e.g., (t<1)) increase while the denoising FIDs at larger t (e.g., (t>1)) (including the generation FID at the largest t=80) continue to decrease. This suggests that the model struggles to learn to denoise and generate simultaneously and sacrifices one for the other.

As such, embodiments of the present disclosure utilize truncated consistency models (TCMs) that are trained using a multi-stage training framework (e.g., a truncated consistency model training framework), which is described and shown in FIG. 1B. For instance, FIG. 1B shows a multi-stage training framework 120 for training truncated consistency models, in accordance with an embodiment. The multi-stage training framework 120 includes a first stage 122 and a second stage 124. In the first stage 122, standard (e.g., traditional) consistency training is used and in the second stage 124, truncated consistency training is used.

As shown in the first stage 122, at any time step between t=0 and t=T (e.g., between time steps 102-118 from FIG. 1A), the consistency model is configured to generate the clean data at t=0 (e.g., the original image from the time step 102). During the first stage 122, a first sampled time step (e.g., the time step 112 from FIG. 1A) may be obtained. Then, using the data from the first sampled time step (e.g., the noisy image associated with the time step 112), the consistency model attempts to generate the clean data (e.g., the image at time step 102). Furthermore, for traditional consistency training at the first stage 122, a second sampled time step may also be obtained based on the first sampled time step and a time step difference (Δₜ). For instance, based on the first sampled time step (e.g., the time step 112) and the time step difference (e.g., Δₜ=2), then a second sampled time step, such as the time step 108, may obtained (e.g., the time step 112 minus the time step difference of 2, which would result in the time step 108). The consistency model attempts to generate the clean data based on the data from the second sampled time step (e.g., the time step 108). Then, based on the generated clean data associated with the first sampled time step (e.g., the first training clean data) and the generated clean data associated with the second sampled time step (e.g., the second training clean data), a loss is determined and used to train the consistency model.

Only nine time steps 102-118 are shown in FIG. 1A for ease of understanding. However, during training of the consistency model, there may be any number of time steps that are utilized to transform the clean data (e.g., the clean image at time step 102) to the noisy data (e.g., a Gaussian distribution of noise at time step 118). For instance, the time step 118 may be represented by T, which may be a numerical value such as 80. In some examples, having the time step 118 equal to 80 (i.e., T=80) might not indicate 80 or 81 total time steps, but may indicate even additional time steps. For instance, if t=0 at time step 102 and t=T or 80 at time step 118, the time step 112 may indicate t=1.0. As such, the value of t may be a decimal number (e.g., 1.2 or 0.8, which are shown in FIGS. 2A-2D below) that indicates the amount of noise that has been added to the clean data (e.g., a noise function that is based on t, and adds noise to the clean data at time step 102).

Thus, at the first stage 122, at each training iteration, the training of the consistency model may include obtaining two time step samples (e.g., two t values). The first time step sample (e.g., the first t value) may be obtained based on a probability distribution. In other words, a time sampling probability distribution may dictate the probability of a time step to be sampled during training. Then, based on the time step difference (Δₜ) and first time step sample, the second time step sample may be obtained. For instance, if the time step difference (Δₜ) is 0.2 and the first sampled time step is 1.3, then the second time step sample would be 1.1 (i.e., the first time step (1.3) minus the time step difference (0.2) which is 1.1). Following, the consistency model may predict (e.g., generate) clean data (e.g., the image at time step 102 (t=0)). Then, based on the predicted clean data and a loss function, the parameters of the consistency model are trained. This is described above. As such, the consistency model performs consistency training such that at any time step samples, the generated clean data would be substantially similar.

In addition, the time step difference (Δₜ) may decrease at further training iterations. For instance, the time step difference may represent a nonnegative difference between two consecutive time steps that is usually set to a monotonically increasing function of t. In other words, as mentioned above, the time step difference may be large at the beginning of training, which incurs biased gradients but allows for stable training, and is annealed in the later training iterations, which reduces the error term but increases variance.

After completing the first stage 122 of training (e.g., traditional or conventional consistency training), the multi-stage training framework 120 may perform a second stage 124 of training. For example, the second stage 124 of the framework 120 may aim to explicitly control the trade-off described above by forcing the consistency training to ignore the denoising task for smaller values of t. This may thus improve its capacity usage for generation. Therefore, embodiments of the present disclosure generalize the consistency model objective of Eq. (4) above and apply the consistency model objective to only the truncated time range [t′, T] where the dividing time t′ lies within (0, T). The time probability ψₜ at the second stage 124 may only have support in [t′, T] as a result.

In other words, referring to FIG. 1A, a time step between time steps 102-118 is selected (e.g., determined), which indicates a truncated time step. For instance, referring to second stage 124, the time step 112 (e.g., t=1.0) may be selected (e.g., t′=1.0). Thus, based on the example above of the final time step 118 (e.g., time step associated with total Gaussian noise) indicating t=T, the second stage 124 only samples between the truncated time range (e.g., from time step 112 to time step 118, which is indicated by the truncated time range [t′, T]). In this second stage 124, the sampling that is used for training of the consistency model may be similar to the sampling that is used for training of the consistency model in the first stage 122 except that the first time step sample cannot be selected between t=0 and t=t′ (e.g., the time steps 102-112). Instead, based on using a second probability distribution (e.g., a Student T probability distribution), the first time step sample may be selected within the truncated time range [t′, T]. The multi-stage training framework 120 as well as the first and second stages 122 and 124 are described in further detail in FIG. 1C.

In some instances, instead of using the multi-stage training framework 120, a naïve, straightforward approach may be to directly train a consistency model on the truncated time range. However, in some examples, a model trained using this approach may have model outputs that collapse to an arbitrary constant because a constant function (e.g., f_{θ}(x, t)=const) is a minimizer of the consistency training objective (Eq. (4)). In standard consistency models, the boundary condition f(x₀, 0)=x₀ prevents collapse, but in this example, there may be no such meaningful boundary condition. For example, if the free-form neural network F_{θ}(x, t)=−cₛₖᵢₚ(t)x/cₒᵤt(t) for all t∈[t′, T], f_{θ}(x, t) is 0, and thus Eq. (4) becomes zero. To handle this, embodiments of the present disclosure may utilize the multi-stage training framework 120 that uses a two-stage training approach (e.g., the first and second stages 122 and 124), which may be configured to use a new parameterization with a proper boundary condition.

FIG. 1C shows an overview 150 of training a truncated consistency model, in accordance with an embodiment. Each block of the overview 150, described herein, may comprise a computing process that may be performed using any combination of hardware, firmware, and/or software. For instance, various functions may be carried out by a processor executing instructions stored in memory. The overview 150 may also be embodied as computer-usable instructions stored on computer storage media. The overview 150 may be provided by a standalone application, a service or hosted service (standalone or in combination with another hosted service), or a plug-in to another product, to name a few. In addition, the overview 150 is described, by way of example, with respect to a computing system and/or platform. However, this overview 150 may additionally or alternatively be executed by any one system, or any combination of systems, including, but not limited to, those described herein. Furthermore, persons of ordinary skill in the art will understand that any system that performs the overview 150 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

In addition, one or more computing systems or computing platforms may be used to perform one or more blocks of the overview 150. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location.

In operation, at block 152, a first stage 122 of truncated consistency training using a plurality of time steps (e.g., the time steps 102-118) is performed. Following, at block 154, a truncated time range (e.g., the truncated time range [t′, T]) is obtained for the plurality of time steps 102-118. The truncated time range (e.g., the time range from time steps 112-118) is a subset of the plurality of time steps (e.g., time steps 102-118) and does not include all of the plurality of time steps.

At block 156, the second stage 124 of truncated consistency training using the truncated time range is performed. Block 156 is described in further detail in FIG. 1D below. For instance, FIG. 1D shows an exemplary process 170 for performing a second stage 124 (e.g., block 156) of the multi-stage training framework 120 for training truncated consistency models, in accordance with an embodiment.

In operation, at block 172, a probability distribution (e.g., a Student T distribution) is used to obtain samples. For example, as mentioned previously, at the first stage 122 and for every iteration, two time step samples are obtained. In the first stage 122, utilizing a first probability distribution, the first time step sample is obtained from a time range of t=0 to t=T (e.g., if T=80, then the time range is between 0 to 80). In the second stage 124, utilizing a second probability distribution (e.g., a probability distribution that is based on a Student T distribution), the first time step sample is obtained from a truncated time range of t=t′ to t=T. In some examples, the second probability distribution used in the second stage 124 may be different from the first probability distribution used in the first stage 122. For instance, in some variations, the second probability distribution that is used to obtain the first time step sample in the second stage 124 may be represented below:

$${ψ}_{t} ( t ) = {λ}_{b} δ ( t - {t}^{′} ) + ( 1 - {λ}_{b} ) {\overline{ψ}}_{t} ( t )$$

where ψₜ(t) is the second probability distribution, t and t′ are described above, λ_{b} is a weighting coefficient, δ is a Dirac delta function, and ψ̅ₜ(t) is another probability distribution such as a Student T distribution. For instance, to prevent collapsing to a constant during training, in the second stage 124, the multi-stage training framework 120 uses two terms: a boundary loss, which uses the time step samples obtained from the Dirac delta function (δ), and a consistency loss, which uses the time step samples obtained from ψ̅ₜ(t) (e.g., a Student T distribution). For example, for each mini-batch of size B that is used for training of the TCM during the second stage 124, the mini-batches are partitioned into two subsets—a first subset that is based on the Dirac delta function (δ) and a second subset that is based on ψ̅ₜ(t) (e.g., a Student T distribution). The number of first samples within the two subsets may be based on the weighting coefficient λ_{b}. As such, for the first subset, a number of first samples (e.g., Bλ_{b}) may be obtained utilizing the Dirac delta function (δ) such that the samples may be represented by t′. For the second subset, another number of first samples (e.g., B(1−λ_{b})) may be obtained utilizing the probability distribution ψ̅ₜ(t) (e.g., a Student T distribution).

In other words, for each training batch, a number of first samples are obtained (e.g., samples represented by t₁ to t_{B} where B indicates the batch size). Then, for the first subset (e.g., t₁ to t_{N}_{_{B}}) that are obtained utilizing the Dirac delta function (δ)), all of the first sample values are set to t′ (e.g., in the example above, t′=1.0, and thus all of the samples t₁ to t_{N}_{_{B}} are set to 1.0). Following, for the second subset (e.g., t_{N}_{_{B}}₊₁ to t_{B}), the time samples are based on the distribution ψ̅ₜ(t) (e.g., a Student T distribution). Subsequently, based on the time step difference (Δₜ), which is described above, the second time step samples may be obtained.

At blocks 174 and 176, using the first and second time step samples, the boundary loss and the consistency loss may be obtained. For example, returning back to block 152 of FIG. 1C, after performing the first stage 122 and completing the standard consistency model training, a trained consistency model may be obtained. Then, for the second stage 124 and block 156, the trained consistency model may be copied such that there are two trained consistency models—a first stage consistency model and a second stage consistency model (e.g., a copied version of the trained consistency model). For the second stage 124, the first stage consistency model may be used, but might not be trained further (e.g., the parameters of the first stage consistency model might not be further trained and may be frozen) and the training may be performed only on the second stage consistency model (e.g., the parameters of the second stage consistency model may be trained further using the truncated time range).

Using the first stage consistency model and the second stage consistency model, the boundary loss and the consistency loss may be obtained. For example, the parameters of the first stage consistency model may be frozen and might not be trained during the second stage 124. But, the data (e.g., the noisy images) associated with time steps that are below t′ may be provided to the first stage consistency model to generate clean data (e.g., the clean image at time step 102). For example, even though at the second stage 124, the first time samples are always between the truncated time range (e.g., between t=t′ and t=T), the second time samples might not be between the truncated time range due to the time step difference (Δₜ). For example, given that the second time samples are obtained based on subtracting the time step difference (Δₜ) from the first time sample, the second time samples may have a time step that is below t′. Thus, for the second time samples that are below t′, the first stage consistency model may be utilized to generate the predicted clean data at time step 102. For the second time samples that indicate t′ (e.g., time samples from the first subset), the second stage consistency model may be utilized to generate the predicted clean data at time step 102. A comparison between the two predicted clean data may be performed, and a boundary loss associated with the first and second time samples may be obtained based on the comparison. Then, to obtain the overall boundary loss for the mini-batch, all of the losses based on comparisons between the predicted clean data using the first stage consistency model and the predicted clean data using the second stage consistency model may be aggregated.

Furthermore, to obtain the consistency loss, the second stage consistency model may be utilized. For instance, as mentioned above, in the second subset, the first time step samples are obtained within the truncated time range [t′, T] using another distribution such as a Student T distribution. Following, the second time steps samples may also be obtained based on the first time step samples and the time step difference (Δₜ). As such, given that the first time step samples are within the truncated time range, the second time step samples may also be between the truncated time range. Therefore, in such instances, the second stage consistency model may be used to predict clean data (e.g., clean images) for both the first time step samples and the second time step samples. Subsequently, a consistency loss may be obtained based on comparison of the predicted clean data from the first time step samples and the second time step samples using the second stage consistency model. Then, an overall consistency loss may be obtained based on an aggregation of all of the consistency losses using the second stage consistency model.

In some instances, for the second subset, the first time step samples may be obtained within the truncated time range [t′, T]. But, based on the time step difference (Δₜ), the second time step samples may actually fall below t′. This may be rare given that the time step difference during the second stage 124 of consistency training is a small value. However, in such instances, the time step samples from the second subset may be handled similarly to the time step samples from the first subset. For instance, for these time step samples, a boundary loss may be determined using the first and second consistency models. Then, the overall boundary loss for the mini-batch may be based on the boundary loss for these time step samples from the second subset.

At block 178, the truncated consistency model (e.g., the second stage consistency model) may be trained based on the consistency losses and the boundary losses. For example, an overall consistency training loss function (L_{CT}) may be obtained based on the boundary loss and the consistency loss. Following, the gradients may be computed and the parameters of the second stage consistency model may be updated. Then, further training iterations may be performed. As mentioned above, in the further training iterations, the time step difference (Δₜ) may decrease, and thus, the second samples that are obtained from the first subset may continuously be different in each iteration (e.g., closer to t′).

In other words, first, the following parameterization is introduced:

$${f}_{θ , {θ}_{0}^{-}}^{trunc} ( x , t ) = {f}_{θ} ( x , t ) \cdot \{ t \geq {t}^{′} \} + {f}_{{θ}_{0}^{-}} ( x , t ) \cdot \{ t < {t}^{′} \} , \qquad ( 5 )$$

where [symbol] {⋅} is the indicator function, and similarly, θ₀⁻
=stopgrad(θ₀). Intuitively, the final model f_{θ} (e.g., the second consistency model) is used when t≥t′, and the pre-trained
(e.g., the first consistency model) is inquired otherwise. θ may represent the parameters of the model (e.g., the second consistency model) and the minus sign with the θ (e.g.,
may indicate that the parameters of the model are frozen (e.g., a stop gradient may be applied to the first consistency model to freeze the parameters of the first consistency model). This approach ensures that: (1) f_{θ} does not waste its capacity learning in the [0, t′) range, and (2) if f_{θ} is trained well, it will learn to generate data by mimicking the pre-trained model f_{θ}_{ₒ}−
at the boundary. When t′=0, the standard consistency model parameterization of Eq. (3) is recovered. During sampling, as

$${f}_{θ , {θ}_{0}^{-}}^{trunc} = {f}_{θ}$$

for all t∈[t′, T], this parameterization may be discarded and f_{θ} may just be used for generating samples.

To describe the boundary condition, the support of the time sampling distribution ψₜ, i.e., [t′, T] may then be partitioned into two time ranges: (i) the boundary time region Sₜ′:={t∈ [symbol] : t′≤t≤t′+Δₜ}, and (ii) the consistency training time region

$${S}_{{t}^{′}}^{-} {=}^{Δ} [ {t}^{′} , T ] \backslash {S}_{{t}^{′}} = \{ t ∈ ℝ : {t}^{′} + {Δ}_{t} < t \leq T \} .$$

To effectively enforce the boundary condition using the first-stage pre-trained model f_{θ}_{₀}₋, a nonnegligible amount of time samples that are sampled from ψₜ must fall within the interval Sₜ′. Otherwise, the consecutive time steps t and t−Δₜ in consistency training may mostly be larger or equal to t′, limiting the influence of the pre-trained model.

With this time partitioning and the new parameterization, Eq. (4) may be decomposed as follows:

$${ℒ}_{CT} ( {f}_{θ , {θ}_{0}^{-}}^{trunc} , {f}_{{θ}^{-} , {θ}_{0}^{-}}^{trunc} ) = {\underbrace{{\int }_{t ∈ {S}_{{t}^{′}}} {ψ}_{t} ( t ) \frac{ω ( t )}{{Δ}_{t}} d ( {f}_{θ} ( x + t ϵ , t ) , {f}_{{θ}_{0}^{-}} ( x + ( t - {Δ}_{t} ) ϵ , t - {Δ}_{t} ) dt )}}_{Boundary loss} + {\underbrace{{\int }_{s ∈ {S}_{{t}^{′}}^{-}} {ψ}_{t} ( t ) \frac{ω ( t )}{{Δ}_{t}} d ( {f}_{θ} ( x + t ϵ , t ) , {f}_{{θ}^{-}} ( x + ( t - {Δ}_{t} ) ϵ , t - {Δ}_{t} ) dt}}_{Consistency loss} , \qquad ( 6 )$$

where the parameterization in Eq. (5) is applied in the above two time partitions separately, and the expectation over x˜p_{data}, ∈˜ [symbol] (0, 1) is dropped for notation simplicity. In the above, ω(t) may be a weighting function, and in some instances, ω(t) may be set to 1. Further, ∈ may be a standard Gaussian random variable. Unlike standard consistency training, the multi-stage training framework 120 for training the TCM may include two terms: the boundary loss and consistency loss. The boundary loss allows the model to learn from the pre-trained model, preventing collapse to a constant.

Training on the objective of Eq. (6) may still collapse to a constant if the boundary condition is not utilized sufficiently by sampling enough time samples in S_{t′}. In particular, this may happen for Δₜ close to zero when consistency training is near convergence. To prevent this, ψₜ is designed to satisfy ∫_{t∈S}_{_{t′}}ψₜ(t)dt>0. In other words, a strictly positive probability of sampling a point in S_{t′} is provided, even when Δt is close to zero. Specifically, ψₜ is defined as a mixture of the Dirac delta function δ(⋅) at point t′ and another distribution ψ̅ₜ:

$${ψ}_{t} ( t ) = {λ}_{b} δ ( t - {t}^{′} ) + ( 1 - {λ}_{b} ) {\overline{ψ}}_{t} ( t ) , \qquad ( 7 )$$

where the weighting coefficient λ_{b}∈(0,1). ψ̅ₜ has the support (t′, T] and may be instantiated in different ways (e.g., log-normal or log Student T distributions).

By definition, it may be seen that ∫_{t∈S}_{_{t′}}ψₜ(t)dt≥λ_{b}, and λ_{b} controls how significantly the boundary condition is emphasized. Assume that the first-stage consistency model is perfectly trained in [0, t′], i.e., f_{θ}_{₀} (xₜ, t)=x₀ for all t∈[0, t′]. If f_{θ}(x_{t′}, t′)≠f_{θ}_{₀} (x_{t′}, t′), f_{θ} will be penalized by the boundary loss. Minimizing the boundary loss enforces the boundary condition in second-stage model f_{θ} (i.e., f_{θ}(x_{t′}, t′)=f_{θ}_{₀}(x_{t′}, t′)=x₀), while minimizing the consistency loss propagates the boundary condition to the end time (i.e., f_{θ}(x_{T}, T)=f_{θ}(x_{t′}, t′)). Consequently, the loss in Eq. (6) effectively guides the model towards the desired solution f_{θ} (x_{T}, T)=x₀. With the time distribution ψₜ defined in Eq. (7), the training objective becomes

$${ℒ}_{CT} ( {f}_{θ , {θ}_{0}^{-}}^{trunc} , {f}_{{θ}^{-} , {θ}_{0}^{-}}^{trunc} ) \approx {λ}_{b} {\underbrace{\frac{ω ( {t}^{′} )}{{Δ}_{{t}^{′}}} d ( {f}_{θ} ( x + {t}^{′} ϵ , {t}^{′} ) , {f}_{{θ}_{0}^{-}} ( x + ( {t}^{′} - {Δ}_{{t}^{′}} ) ϵ , {t}^{′} - {Δ}_{{t}^{′}} )}}_{Boundary loss := {ℒ}_{B} ( {f}_{θ} , {f}_{{θ}_{0}^{-}} )} + \qquad ( 8 )$$

$$( 1 - {λ}_{b} ) {\underbrace{{𝔼}_{{\overline{ψ}}_{t}} [ \frac{ω ( t )}{{Δ}_{t}} d ( {f}_{θ} ( x + t ϵ , t ) , {f}_{{θ}^{-}} ( x + ( t - {Δ}_{t} ) ϵ , t - {Δ}_{t} ) ]}}_{Consistency loss : {ℒ}_{C} ( {f}_{θ} , {f}_{{θ}^{-}} )} . \qquad ( 9 )$$

where the approximation in Eq. (8) holds when Δₜ is sufficiently small (which is true for the truncated training stage). For simplicity of notation, the above objective is relaxed by absorbing the (1−λ_{b}) factor into λ_{b} and final training loss is expressed as:

$${ℒ}_{TCM} := {w}_{b} {ℒ}_{B} ( {f}_{θ} , {f}_{{θ}_{0}^{-}} ) + {ℒ}_{C} ( {f}_{θ} , {f}_{{θ}^{-}} ) , \qquad ( 10 )$$

where w_{b}=λ_{b}(1−λ_{b}) is a tunable hyperparameter that controls the weighting of the boundary loss.

To estimate the two losses, each mini-batch of size B is partitioned into two subsets. The boundary loss L_{B} is estimated using a subset of the mini-batch with N_{B}=└Bρ┘ samples, where ρ∈(0,1) is a hyperparameter controlling the allocation of samples and the symbol └⋅┘ represents an operator that rounds down and returns the largest integer less than or equal to a given number. The consistency loss L_{c} is estimated with the remaining B−N_{B} samples. Increasing ρ reduces the variance of the boundary loss gradient estimator but increases the variance of the consistency loss gradient estimator, and vice versa. The final mini-batch loss is as follows:

$${ℒ}_{TCM} \approx \frac{{w}_{b}}{{N}_{B}} {\sum }_{i = 1}^{{N}_{B}} {∇}_{θ} {( {ℒ}_{B} )}_{i} ( {f}_{θ} , {f}_{{θ}_{0}^{-}} ) + \frac{1}{B - {N}_{B}} {\sum }_{j = {N}_{B} + 1}^{B} {∇}_{θ} {( {ℒ}_{C} )}_{j} ( {f}_{θ} , {f}_{{θ}^{-}} ) , \qquad ( 11 )$$

where ( [symbol] )ᵢ and ( [symbol] )ⱼ are the boundary loss and the consistency loss at the i-th sample from δ(t−t′) and the j-th sample from ψ̅t, respectively.

The training of the truncated consistency model is summarized in the Algorithm 1, which is shown in FIG. 1E. For instance, FIG. 1E shows an algorithm 190 for performing truncated consistency training, in accordance with an embodiment. For example, at a first step, the standard consistency training is performed (e.g., block 152 of overview 150 is performed). At a second step, the consistency training loss is optimized for the regular model. Then, at a third step, truncated training is performed (e.g., block 156 of overview 150 is performed) using steps four through eleven. For example, at a fourth step, a number of boundary samples are obtained. Then, at a fifth step, for each training iteration, steps six through eleven are performed. Steps six through eleven are described above, such as in context with Eq. (8) and Eq. (9) that are shown above. At the twelfth step, the algorithm 190 ends.

In some examples, at blocks 152 and/or 156, prior to performing the comparisons to obtain the losses, additional noise may be added to the predicted clean image. For example, after using the first and/or second stage consistency models to generate the predicted clean data (e.g., the predicted clean image), another step of the training may be performed and additional noise may be added to the predicted clean data. For example, referring to block 156 above and after obtaining the first and second time step samples, the first and/or second stage consistency models may be used to generate a first and a second predicted clean data (e.g., two predicted clean images). Subsequently, instead of comparing the first and second predicted clean data to obtain a boundary and/or consistency loss, the training may be a multi-step training process. In a second step, the training may include adding an amount of noise (e.g., an amount of noise associated with t′) to the first and second predicted clean data. Then, the first and/or second stage consistency models may be used to generate new predicted clean data based on processing the new noisy data (e.g., the new noisy data that is obtained based on adding the amount of noise to the first and second predicted clean data). After obtaining the new predicted clean data (e.g., the first and second new predicted clean data), a comparison may be performed between the new predicted clean data to obtain the boundary and/or consistency losses.

At block 158, the trained truncated consistency model is used to perform one or more tasks such as performing image and/or video generation. For example, after performing the multi-stage training framework 120, the trained truncated consistency model may be used to generate clean data such as images and/or videos. For instance, as mentioned above, during inference, based on sampling from a noise distribution and/or based on a user prompt, the trained truncated consistency model may be used to generate clean data such as images and/or videos (e.g., generate clean data at time step 102 (t=0) based on noise samples from time step 118 (t=T)).

In some examples, referring to block 154, the truncated time range (e.g., the truncated time step t′) may be obtained based on a denoising Fréchet inception distance (dFID) associated with the time steps. The dFID associated with different time steps is shown in FIGS. 2A-2D and may be obtained based on performing block 152. For instance, FIGS. 2A-2D show graphical representations 200, 210, 220, and 230 of dFIDs at different time steps and a plurality of training iterations, in accordance with an embodiment.

For instance, as shown in graphical representations 200, 210, 220, and 230, for t being less than 1.0 (e.g., the graphs 202, 204, and 212), there is an increase in the dFID at later iterations, including a peak that is shown after performing 300,000 iterations. In contrast, after a certain time step, the increase at the later iterations is reduced or non-existent and there is not a further peak at the later iterations. For instance, as shown in the graph 214, for t=0, the increase is nearly non-existent. This is further shown in graphs 222, 224, 232, and 234.

Thus, based on this, a truncated time step t′ may be determined such as based on comparing the data associated with the dFID graphical representations with one or more thresholds (e.g., based on the dFID values at later iterations such as iterations after 125,000 iterations not increasing above a pre-determined threshold such as 1.0). As such, the truncated time step t′ at t=1 may be selected and used for the second stage 124 of training the truncated consistency model.

Among other benefits and advantages, embodiments of the present disclosure provide a multi-stage training framework 120 that includes a first stage 122 and a second stage 124. The first stage 122 includes training a consistency model using a standard consistency training and the second stage 124 includes training a truncated consistency model using a truncated consistency training. The truncated consistency training includes obtaining time step samples (e.g., the first time step samples) that are within a truncated time range [t′, T]. Additionally, and/or alternatively, the second stage 124 includes training a truncated consistency model using a boundary loss and a consistency loss. The boundary loss is determined based on a first stage consistency model and a second stage consistency model (e.g., a copy of the first stage consistency model that is further trained during the second stage 124) and the consistency loss is determined based on using the second stage consistency model. Additionally, and/or alternatively, the time step samples obtained in the second stage 124 that are within the truncated time range [t′, T] are based on using a Student T distribution.

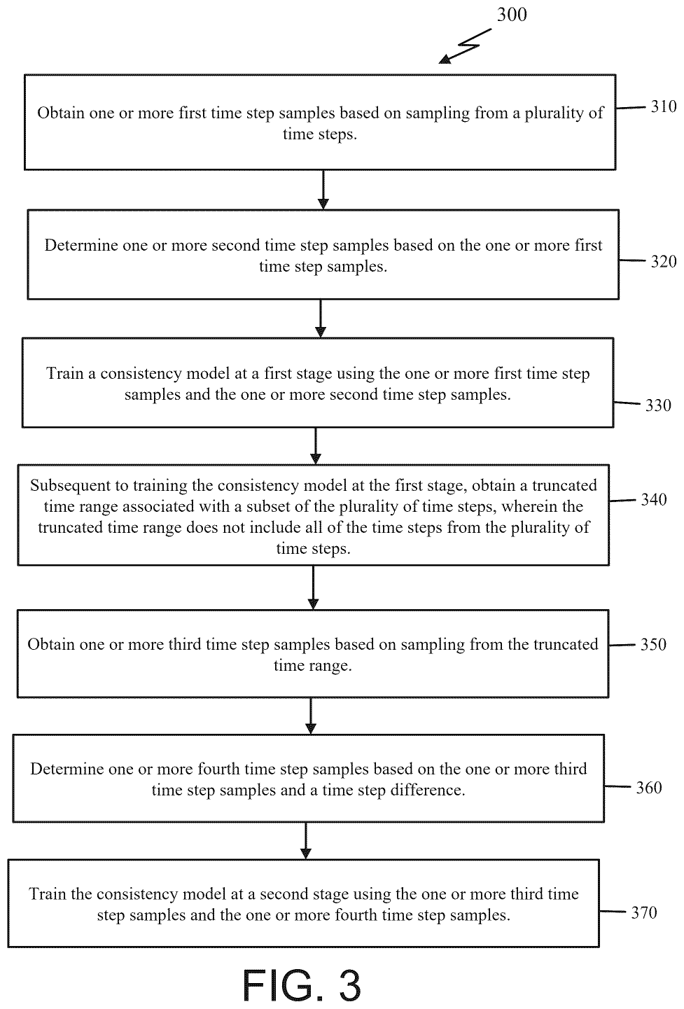

FIG. 3 provides a flow diagram illustrating a method 300 for performing a truncated consistency model training framework, in accordance with an embodiment. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the overview 150 and the multi-frame training framework 120. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, one or more first time step samples are obtained based on sampling from a plurality of time steps.

At step 320, one or more second time step samples are determined based on the one or more first time step samples.

At step 330, a consistency model is trained at a first stage using the one or more first time step samples and the one or more second time step samples.

At step 340, subsequent to training the consistency model at the first stage, a truncated time range associated with a subset of the plurality of time steps is obtained. The truncated time range does not include all of the time steps from the plurality of time steps. In an embodiment, obtaining the truncated time range comprises obtaining a truncated time step that is within the plurality of time steps, and separating the plurality of time steps into an initial time range and the truncated time range based on the truncated time step. The initial time range comprises an initial time step that is associated with clean data and the truncated time range comprises a final time step that is associated with data indicating Gaussian noise.

In an embodiment, obtaining the truncated time step comprises: determining denoising Fréchet inception distances (dFIDs) associated with the plurality of time steps over a plurality of iterations, comparing the dFIDs associated with the plurality of time steps over the plurality of iterations with one or more thresholds, and determining the truncated time step based on the comparison.

At step 350, one or more third time step samples are obtained based on sampling from the truncated time range. In an embodiment, obtaining one or more third time step samples comprises obtaining the one or more third time step samples by sampling from the truncated time range using a probability distribution and a weighting coefficient. In an embodiment, the probability distribution is a Student T probability distribution.

At step 360, one or more fourth time step samples are determined based on the one or more third time step samples and a time step difference.

At step 370, the consistency model is trained at a second stage using the one or more third time step samples and the one or more fourth time step samples. In an embodiment, training the consistency model at the second stage comprises copying the trained consistency model from the first stage to obtain a first stage consistency model and a second stage consistency model and training the second stage consistency model at the second stage using the one or more third time step samples and the one or more fourth time step samples. In an embodiment, the one or more third time step samples comprises a plurality of third time step samples and the one or more fourth time step samples comprises a plurality of fourth time step samples. Further, each of time step sample from the plurality of fourth time step samples is associated with a time step sample from the plurality of third time step samples. Also, training the second stage consistency model at the second stage comprises: computing a boundary loss based on a first subset of time step samples comprising a first subset of the plurality of fourth time step samples and a first subset of the plurality of third time step samples that are associated with the first subset of the plurality of fourth time step samples, computing a consistency loss based on a second subset of time step samples comprising a second subset of the plurality of fourth time step samples and a second subset of the plurality of third time step samples that are associated with the second subset of the plurality of fourth time step samples, and training the second stage consistency model at the second stage based on the boundary loss and the consistency loss.

In an embodiment, computing the boundary loss comprises: processing the first subset of the plurality of fourth time step samples using the first stage consistency model to obtain first predicted clean data, processing the first subset of the plurality of third time step samples using the second stage consistency model to obtain second predicted clean data, and computing the boundary loss based on comparing the first predicted clean data and the second predicted clean data.

In an embodiment, computing the consistency loss comprises processing the second subset of the plurality of fourth time step samples and the second subset of the plurality of third time step samples using the second stage consistency model to obtain first predicted clean data and second predicted clean data and computing the consistency loss based on comparing the first predicted clean data and the second predicted clean data.

In an embodiment, training the second stage consistency model at the second stage further comprises: sorting the plurality of fourth time step samples into the second subset of the plurality of fourth time step samples based on a time step sample from the plurality of fourth time step samples being within the truncated time range; and sorting the plurality of fourth time step samples into the first subset of the plurality of fourth time step samples based on the time step sample from the plurality of fourth time step samples being outside of the truncated time range.

In an embodiment, training the second stage consistency model at the second stage comprises: processing the one or more third time step samples and the one or more fourth time step samples using the second stage consistency model to generate a first predicted clean data and a second predicted clean data; adding noise to the first predicted clean data and second predicted clean data to generate first noisy data and second noisy data; processing the first noisy data and the second noisy data using the second stage consistency model to generate a first newly predicted clean data and a second newly predicted clean data; determining one or more losses based on comparing the first newly predicted clean data and the second newly predicted clean data; and training the second stage consistency model based on the one or more determined losses.

In an embodiment, method 300 further includes subsequent to training of the consistency model at the second stage, using the trained consistency model to perform image generation or video generation.

In an embodiment, at least one of steps 310-370 and/or the further steps described above for method 300 are performed on a server or in a data center to generate an image or video, and the image or video is streamed to a user device. In an embodiment, at least one of steps 310-370 and/or the further steps described above for method 300 is performed within a cloud computing environment. In an embodiment, at least one of steps 310-370 and/or the further steps described above for method 300 is performed for training, testing, or certifying a neural network employed in a machine, robot, or autonomous vehicle. In an embodiment, at least one of steps 310-370 and/or the further steps described above for method 300 is performed on a virtual machine comprising a portion of a graphics processing unit.

In some examples, embodiments of the present disclosure generalize consistency training to the truncated time range, which allows the model to ignore denoising tasks at earlier time steps and focus its capacity on generation. Additionally, and/or alternatively, embodiments of the present disclosure describe a new parameterization of the consistency function and a two-stage training procedure that prevents the truncated-time training from collapsing to a trivial solution. For example, embodiments of the present disclosure may utilize a multi-stage training framework that includes a first stage and a second stage. The first stage includes training a consistency model using standard consistency training and the second stage includes training a truncated consistency model using truncated consistency training. The truncated consistency training includes obtaining time step samples that are within a truncated time range [t′, T]. Furthermore, at the second stage, the training of the truncated consistency model utilizes a boundary loss and a consistency loss. The boundary loss is determined based on a first stage consistency model and a second stage consistency model (e.g., a copy of the first stage consistency model that is further trained during the second stage) and the consistency loss is determined based on using the second stage consistency model.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

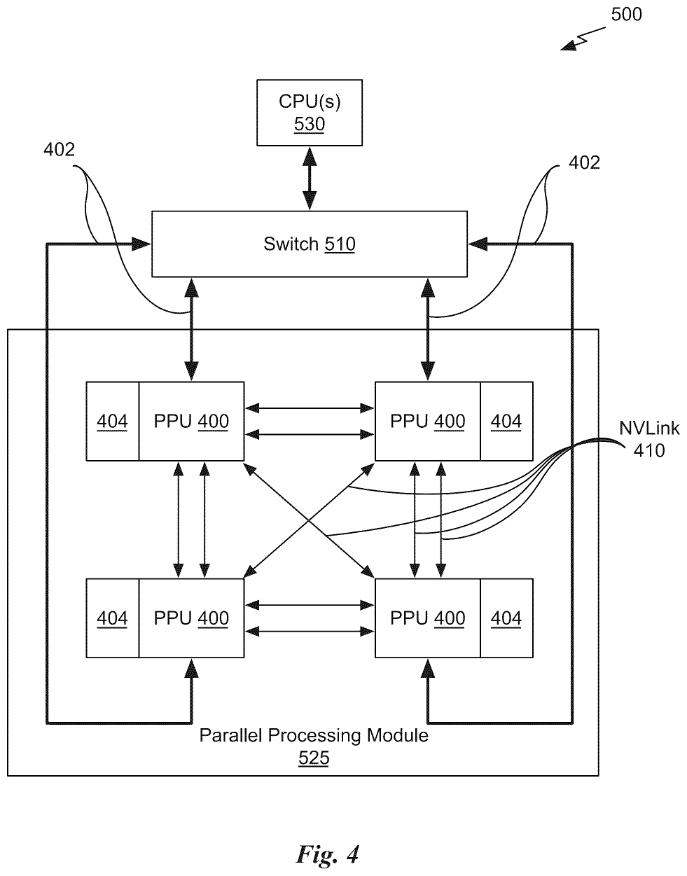

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

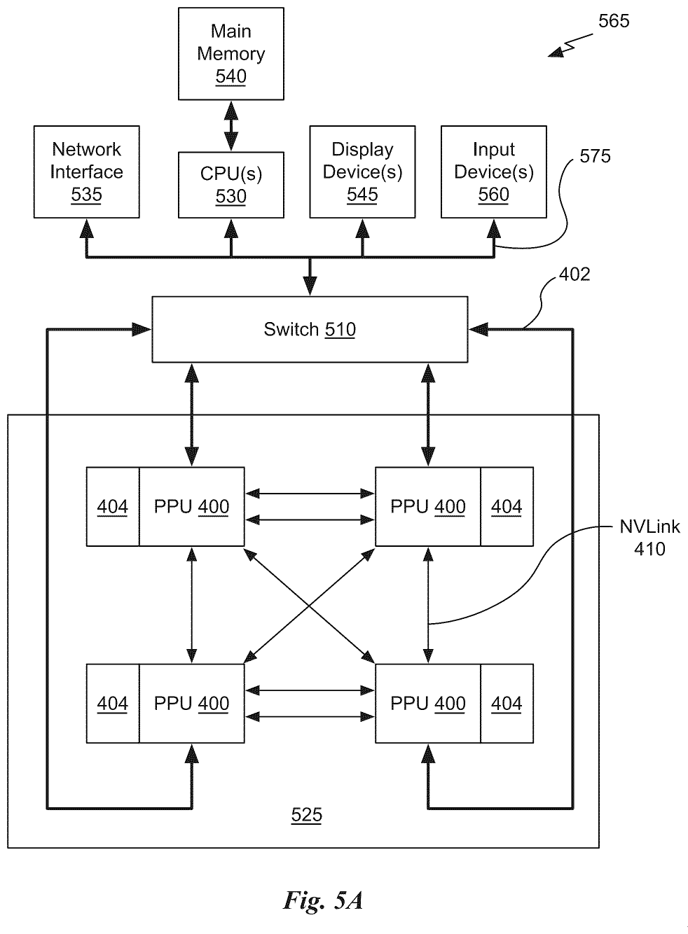

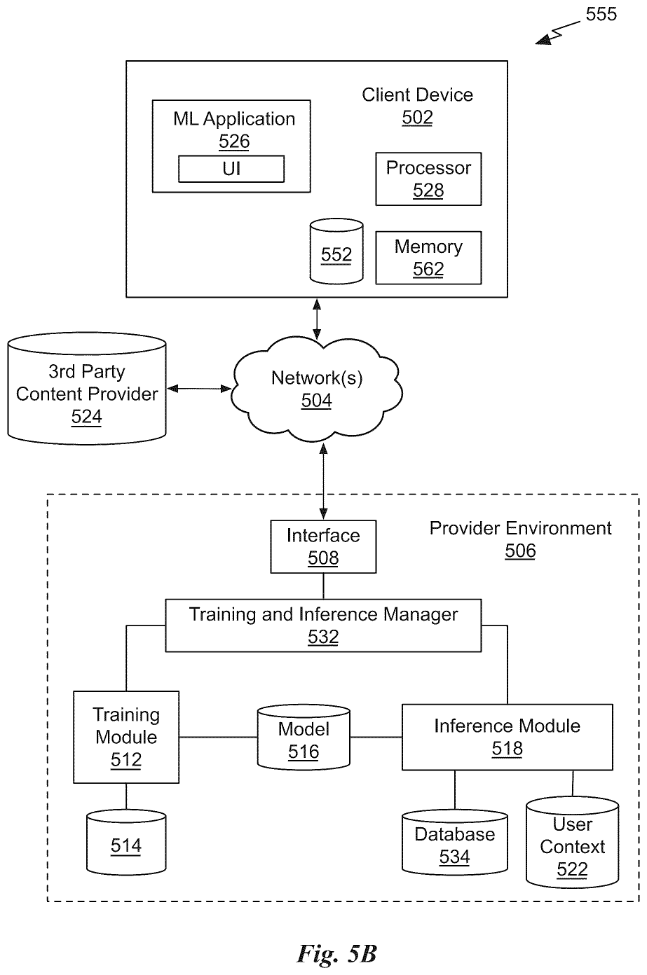

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

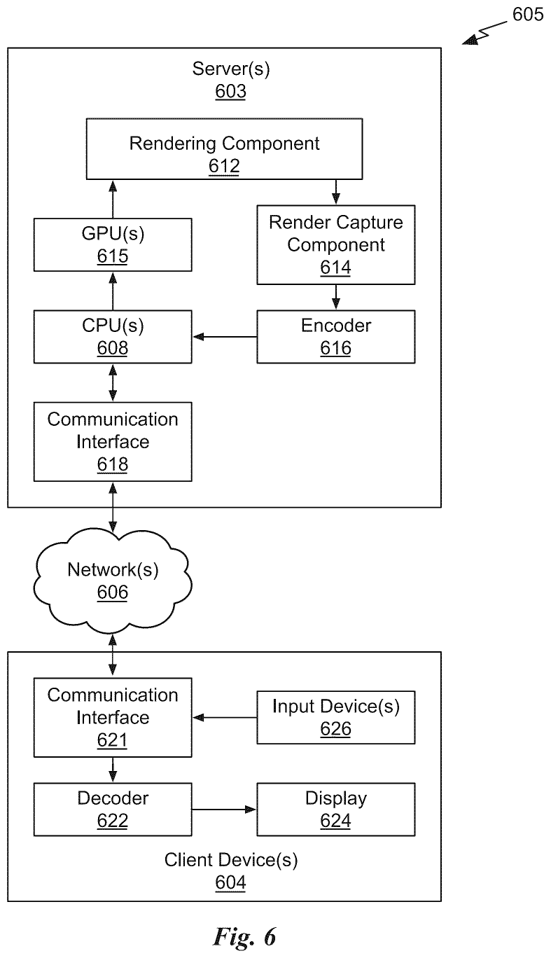

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for performing a truncated consistency model training framework, comprising:
obtaining one or more first time step samples based on sampling from a plurality of time steps;
determining one or more second time step samples based on the one or more first time step samples;
training a consistency model at a first stage using the one or more first time step samples and the one or more second time step samples;
subsequent to training the consistency model at the first stage, obtaining a truncated time range associated with a subset of the plurality of time steps, wherein the truncated time range does not include all of the time steps from the plurality of time steps;
obtaining one or more third time step samples based on sampling from the truncated time range;
determining one or more fourth time step samples based on the one or more third time step samples and a time step difference; and
training the consistency model at a second stage using the one or more third time step samples and the one or more fourth time step samples.

2. The computer-implemented method of claim 1, further comprising:
subsequent to training of the consistency model at the second stage, using the trained consistency model to perform image generation or video generation.

3. The computer-implemented method of claim 1, wherein obtaining the truncated time range comprises:
obtaining a truncated time step that is within the plurality of time steps; and
separating the plurality of time steps into an initial time range and the truncated time range based on the truncated time step, wherein the initial time range comprises an initial time step that is associated with clean data and the truncated time range comprises a final time step that is associated with data indicating Gaussian noise.

4. The computer-implemented method of claim 3, wherein obtaining the truncated time step comprises:
determining denoising Fréchet inception distances (dFIDs) associated with the plurality of time steps over a plurality of iterations;
comparing the dFIDs associated with the plurality of time steps over the plurality of iterations with one or more thresholds; and
determining the truncated time step based on the comparison.

5. The computer-implemented method of claim 1, wherein obtaining one or more third time step samples comprises:
obtaining the one or more third time step samples by sampling from the truncated time range using a probability distribution and a weighting coefficient.

6. The computer-implemented method of claim 5, wherein the probability distribution is a Student T probability distribution.

7. The computer-implemented method of claim 1, wherein training the consistency model at the second stage comprises:
copying the trained consistency model from the first stage to obtain a first stage consistency model and a second stage consistency model; and
training the second stage consistency model at the second stage using the one or more third time step samples and the one or more fourth time step samples.

8. The computer-implemented method of claim 7, wherein the one or more third time step samples comprises a plurality of third time step samples and the one or more fourth time step samples comprises a plurality of fourth time step samples, wherein each of time step sample from the plurality of fourth time step samples is associated with a time step sample from the plurality of third time step samples, and wherein training the second stage consistency model at the second stage comprises:
computing a boundary loss based on a first subset of time step samples comprising a first subset of the plurality of fourth time step samples and a first subset of the plurality of third time step samples that are associated with the first subset of the plurality of fourth time step samples;
computing a consistency loss based on a second subset of time step samples comprising a second subset of the plurality of fourth time step samples and a second subset of the plurality of third time step samples that are associated with the second subset of the plurality of fourth time step samples; and
training the second stage consistency model at the second stage based on the boundary loss and the consistency loss.

9. The computer-implemented method of claim 8, wherein computing the boundary loss comprises:
processing the first subset of the plurality of fourth time step samples using the first stage consistency model to obtain first predicted clean data;
processing the first subset of the plurality of third time step samples using the second stage consistency model to obtain second predicted clean data; and
computing the boundary loss based on comparing the first predicted clean data and the second predicted clean data.

10. The computer-implemented method of claim 8, wherein computing the consistency loss comprises:
processing the second subset of the plurality of fourth time step samples and the second subset of the plurality of third time step samples using the second stage consistency model to obtain first predicted clean data and second predicted clean data; and
computing the consistency loss based on comparing the first predicted clean data and the second predicted clean data.

11. The computer-implemented method of claim 8, wherein training the second stage consistency model at the second stage further comprises:
sorting the plurality of fourth time step samples into the second subset of the plurality of fourth time step samples based on a time step sample from the plurality of fourth time step samples being within the truncated time range; and
sorting the plurality of fourth time step samples into the first subset of the plurality of fourth time step samples based on the time step sample from the plurality of fourth time step samples being outside of the truncated time range.

12. The computer-implemented method of claim 7, wherein training the second stage consistency model at the second stage comprises:
processing the one or more third time step samples and the one or more fourth time step samples using the second stage consistency model to generate a first predicted clean data and a second predicted clean data;
adding noise to the first predicted clean data and second predicted clean data to generate first noisy data and second noisy data;
processing the first noisy data and the second noisy data using the second stage consistency model to generate a first newly predicted clean data and a second newly predicted clean data;
determining one or more losses based on comparing the first newly predicted clean data and the second newly predicted clean data; and
training the second stage consistency model based on the one or more determined losses.

13. The computer-implemented method of claim 1, wherein at least one of the steps of obtaining, determining, and training are performed on a server or in a data center to generate an image or video, and the image or video is streamed to a user device.

14. The computer-implemented method of claim 1, wherein at least one of the steps of obtaining, determining, and training are performed within a cloud computing environment.

15. The computer-implemented method of claim 1, wherein at least one of the steps of obtaining, determining, and training are performed for training, testing, or certifying a neural network employed in a machine, robot, or autonomous vehicle.

16. The computer-implemented method of claim 1, wherein at least one of the steps of obtaining, determining, and training is performed on a virtual machine comprising a portion of a graphics processing unit.

17. A system for performing a truncated consistency model training framework, comprising:
one or more processors; and
a non-transitory computer-readable medium having processor-executable instructions stored thereon, wherein the processor-executable instructions, when executed by the one or more processors, facilitate:
obtaining one or more first time step samples based on sampling from a plurality of time steps;
determining one or more second time step samples based on the one or more first time step samples;
training a consistency model at a first stage using the one or more first time step samples and the one or more second time step samples;
subsequent to training the consistency model at the first stage, obtaining a truncated time range associated with a subset of the plurality of time steps, wherein the truncated time range does not include all of the time steps from the plurality of time steps;
obtaining one or more third time step samples based on sampling from the truncated time range;
determining one or more fourth time step samples based on the one or more third time step samples and a time step difference; and
training the consistency model at a second stage using the one or more third time step samples and the one or more fourth time step samples.

18. The system of claim 17, wherein the processor-executable instructions, when executed by the one or more processors, further facilitate:
subsequent to training of the consistency model at the second stage, using the trained consistency model to perform image generation or video generation.

19. A non-transitory computer-readable medium having processor-executable instructions stored thereon for performing a truncated consistency model training framework, wherein the processor-executable instructions, when executed, facilitate:
obtaining one or more first time step samples based on sampling from a plurality of time steps;
determining one or more second time step samples based on the one or more first time step samples;
training a consistency model at a first stage using the one or more first time step samples and the one or more second time step samples;
subsequent to training the consistency model at the first stage, obtaining a truncated time range associated with a subset of the plurality of time steps, wherein the truncated time range does not include all of the time steps from the plurality of time steps;
obtaining one or more third time step samples based on sampling from the truncated time range;
determining one or more fourth time step samples based on the one or more third time step samples and a time step difference; and
training the consistency model at a second stage using the one or more third time step samples and the one or more fourth time step samples.

20. The non-transitory computer-readable medium of claim 19, wherein the processor-executable instructions, when executed, further facilitate:
subsequent to training of the consistency model at the second stage, using the trained consistency model to perform image generation or video generation.
